(19) United States
(12) Patent Application Publication
(10) Pub. No.: US 2022/0011869 A1
(43) Pub. Date: Jan. 13, 2022

(54) HAPTIC ACTUATOR LOCATION DETECTION

(71) Applicant: Intel Corporation, Santa Clara, CA (US)

(72) Inventor: Sean Jude William Lawrence, Bangalore (IN)

(73) Assignee: Intel Corporation, Santa Clara, CA (US)

(21) Appl. No.: 17/483,705

(22) Filed: Sep. 23, 2021

(51) Int. Cl. G06F 3/01; G01P 15/00; G06F 1/16

(52) U.S. Cl. CPC G06F 3/016; G06F 1/163; G01P 15/00; G06F 3/011

(57) ABSTRACT

Particular embodiments described herein provide for an electronic device that can be configured to include a virtual reality engine to create a virtual environment for a user, a communication engine in communication with at least one reference point pad on the user, and a haptic actuator location engine to determine a position of one or more removable haptic pads on the user using sensor data from the one or more removable haptic pads and the at least one reference point pad. In an example, the sensor data is motion data from an accelerometer, gyroscope, or some other sensor(s) to detect movement of the one or more removable haptic pads and the at least one reference point pad.

### TECHNICAL FIELD

This disclosure relates in general to the field of computing, and more particularly, to haptic actuator location detection.

### BACKGROUND

Emerging trends in systems place increasing performance demands on the system. One current trend is virtual reality (VR). VR is a simulated experience that can be similar to or completely different from the real world. Applications of VR include entertainment, video games, education, medical training, military training, business applications, virtual meetings, and other applications. Distinct types of VR-style technology include augmented reality and mixed reality, sometimes referred to as extended reality or XR.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIGS. 1A-1C are simplified block diagrams of a system to enable haptic actuator location detection, in accordance with an embodiment of the present disclosure;

FIG. 2 is a simplified block diagram of a portion of a system to enable haptic actuator location detection, in accordance with an embodiment of the present disclosure;

FIG. 3 is a simplified block diagram of a portion of a system to enable haptic actuator location detection, in accordance with an embodiment of the present disclosure;

FIG. 4 is a simplified block diagram of a portion of a system to enable haptic actuator location detection, in accordance with an embodiment of the present disclosure;

FIG. 5 is a simplified block diagram illustrating example details of a system to enable haptic actuator location detection, in accordance with an embodiment of the present disclosure;

FIGS. 6A and 6B are simplified block diagrams of a system to enable haptic actuator location detection, in accordance with an embodiment of the present disclosure;

FIGS. 7A and 7B are simplified block diagrams of a system to enable haptic actuator location detection, in accordance with an embodiment of the present disclosure;

FIGS. 8A-8C are simplified block diagrams of a system to enable haptic actuator location detection, in accordance with an embodiment of the present disclosure;

FIG. 9 is a simplified flowchart illustrating potential operations that may be associated with the system in accordance with an embodiment of the present disclosure;

FIG. 10 is a simplified flowchart illustrating potential operations that may be associated with the system in accordance with an embodiment of the present disclosure;

FIG. 11 is a simplified flowchart illustrating potential operations that may be associated with the system in accordance with an embodiment of the present disclosure; and

FIG. 12 is a simplified block diagram of a system that includes haptic actuator location detection, in accordance with an embodiment of the present disclosure.

The FIGURES of the drawings are not necessarily drawn to scale, as their dimensions can be varied considerably without departing from the scope of the present disclosure.

### DETAILED DESCRIPTION

### Example Embodiments

The following detailed description sets forth examples of apparatuses, methods, and systems relating to enabling haptic actuator location detection. Features such as structure(s), function(s), and/or characteristic(s), for example, are described with reference to one embodiment as a matter of convenience; various embodiments may be implemented with any suitable one or more of the described features.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

The terms “over,” “under,” “below,” “between,” and “on” as used herein refer to a relative position of one layer or component with respect to other layers or components. For example, one layer disposed over or under another layer may be directly in contact with the other layer or may have one or more intervening layers. Moreover, one layer disposed between two layers may be directly in contact with the two layers or may have one or more intervening layers. In contrast, a first layer “directly on” a second layer is in direct contact with that second layer. Similarly, unless explicitly stated otherwise, one feature disposed between two features may be in direct contact with the adjacent features or may have one or more intervening layers.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example. The term “about” indicates a tolerance of twenty percent (20%). For example, about one (1) millimeter (mm) would include one (1) mm and ±0.2 mm from one (1) mm. Similarly, terms indicating orientation of various elements, for example, “coplanar,” “perpendicular,” “orthogonal,” “parallel,” or any other angle between the elements generally refer to being within +/−5-20% of a target value based on the context of a particular value as described herein or as known in the art.

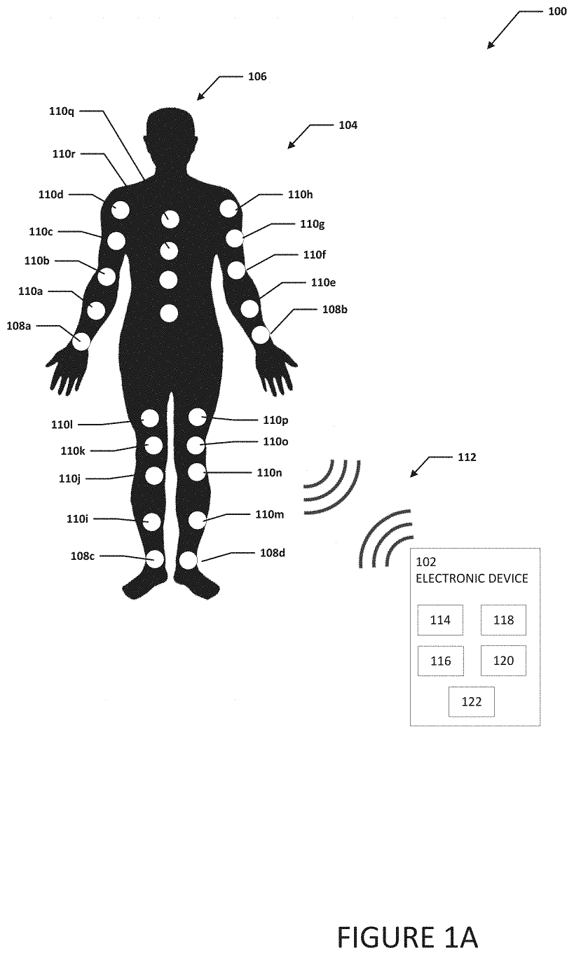

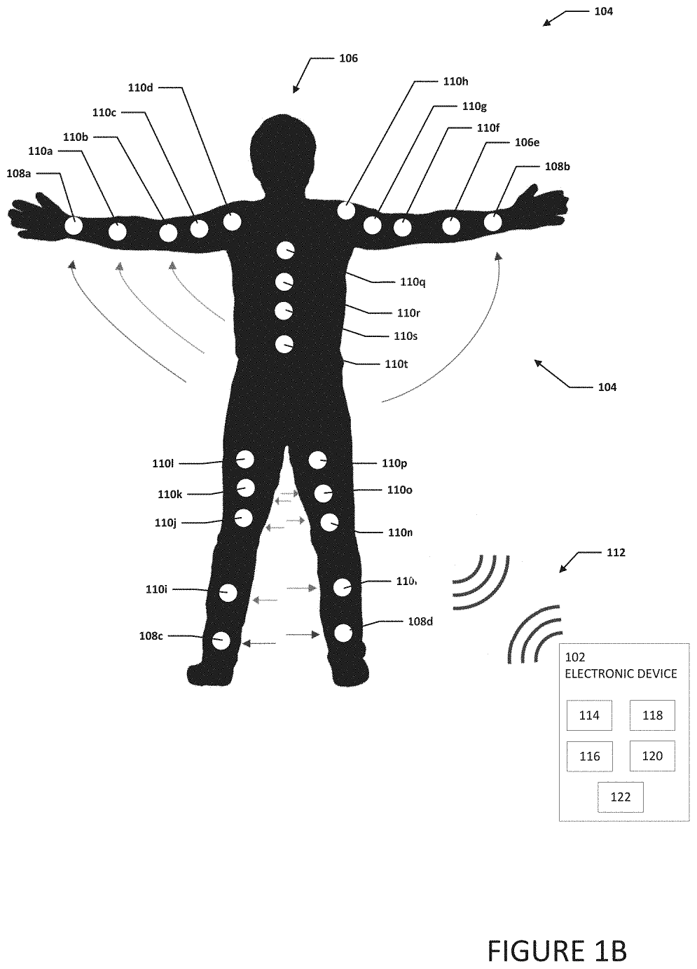

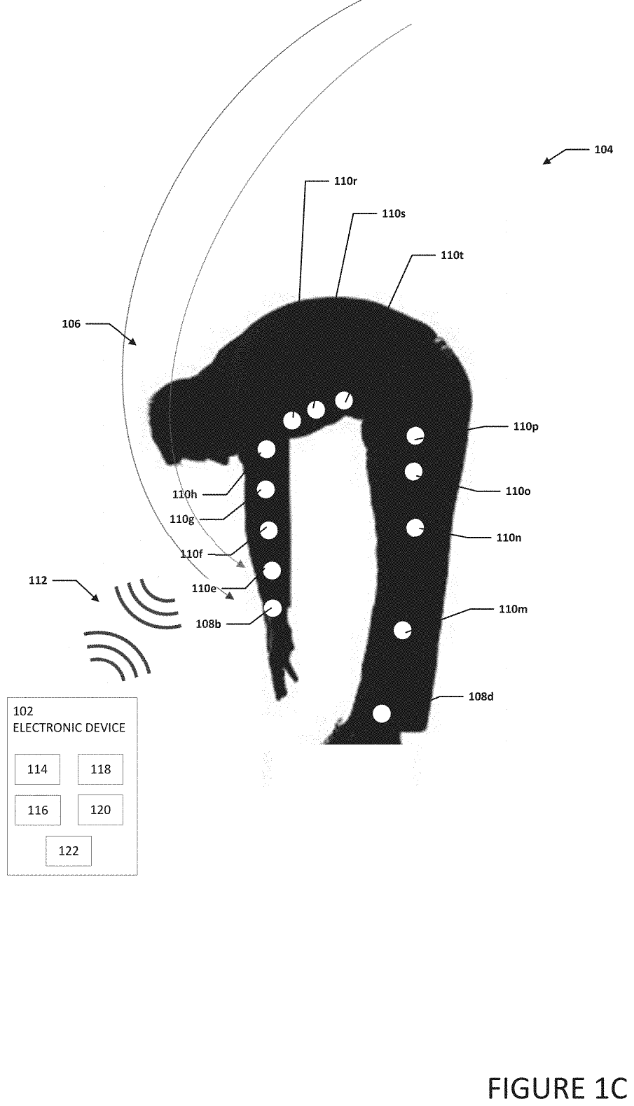

FIGS. 1A-1C are a simplified block diagram of a virtual reality (VR) system 100 configured with haptic actuator location detection, in accordance with an embodiment of the present disclosure. In an example, the VR system can include an electronic device 102 and a haptic system 104. The electronic device 102 can be a base station and/or the primary controller for the VR system 100. The haptic system 104 can be a haptic suit, haptic vest, haptic garment, a plurality of haptic pads or blocks, etc. that is worn by the user 106 and provides feedback to the user 106 when the user 106 is in the VR environment.

The electronic device 102 can include memory 114, one or more processors 116, a VR engine 118, a communication engine 120, and a haptic actuator location engine 122. The VR engine 118 can create and control the VR environment and cause the haptic system 104 to provide feedback to the user 106 when the user 106 is in the VR environment. The haptic actuator location engine 122 can determine the location of haptic actuators in the haptic system 104 and communicate the location of the haptic actuator to the VR engine 118. The haptic system 104 can be hard wired to the electronic device 102 or can be in wireless communication with the electronic device 102. For example, in FIGS. 1A 1C, the haptic system 104 is in communication with the electronic device 102 using a wireless connection 112.

The haptic system 104 can include one or more reference point pads 108 and one or more removable haptic pads 110. For example, as illustrated in FIG. 1A, the haptic system 104 includes four (4) reference point pads 108a-108d and sixteen (16) removable haptic pads 110a-110p. More specifically, the reference point pad 108a is located around or about the right wrist area of the user 106, the reference point pad 108b is located around or about the left wrist area of the user 106, the reference point pad 108c is locate around or about the right ankle area of the user 106, and the reference point pad 108d is located around or about the left ankle area of the user 106. In some examples, the one or more reference point pads 108a-108d can each include an actuator to help provide feedback to the user 106.

In an example, the one or more reference point pads 108 can be reference points that help to determine the location of each of the one or more removable haptic pads 110. More specifically, the location of each of the one or more reference point pads 108 can be known by the haptic actuator location engine 122. Based on the movement of each of the one or more removable haptic pads 110 relative to the one or more reference point pads 108, the location of each of the one or more removable haptic pads 110 can be determined by the haptic actuator location engine 122. The movement of each of the one or more removable haptic pads 110 relative to the one or more reference point pads 108 can be determined by sensors in the one or more removable haptic pads 110 and the one or more reference point pads 108 that can detect the motion of the one or more removable haptic pads 110 and the one or more reference point pads 108 and then communicate the motion data to the haptic actuator location engine 122.

For example, as illustrated in FIG. 1A, the user 106 can be standing with their arms to their side and feet relatively close together. As illustrated in FIG. 1B, the user 106 can raise their arms and move their feet apart. In an example, the movement of the user 106 raising their arms and moving their feet apart can be part of a calibration movement that the user 106 is instructed to perform during an initial set up of the system before the VR experience begins. In another example, the movement of the user 106 raising their arms and moving their feet apart is an “in game” calibration movement and can be a movement that is part of the VR experience. For example, the calibration movement may be a movement that is part of the VR experience the user makes (e.g., the user was flying or jumping) and the system can use the movement as an “in game” calibration movement. In yet another example, because the system knows the location of each of the one or more reference point pads 108, the system can use the one or more reference point pads 108 and determine that the user 106 raised their arms and moved their feet apart. Because the movement of the user is known, motion data from the change in location of the one or more removable haptic pads 110 relative to the one or more reference point pad 108 can be used to determine the position of each of the one or more removable haptic pads 110 relative to the one or more reference point pads 108.

More specifically, as illustrated in FIG. 1B, when the right arm of the user 106 is raised, the reference point pad 108a will move in a movement that is known to the system (e.g., part of a calibration move) or the system can determine the movement based on the known location of the reference point pad 108a, the user's right arm, and the change in location of the reference pad 108a as the user 106 raises their right arm. Because the removable haptic pads 110a-110d are on the same arm of the user 106 as the reference point pad 108a, the removable haptic pads 110a-110d move similar to the reference point pad 108a. Based on the movement of and motion data from each of the removable haptic pads 110a-110d relative to the reference point pad 108a, the location of each of the removable haptic pads 110a-110d can be determined by the haptic actuator location engine 122. Also, when the left arm of the user 106 is raised, the reference point pad 108b will move in a movement that is known to the system (e.g., part of a calibration move) or the system can determine the movement based on the known location of the reference point pad 108b, the user's left arm, and the change in location of the reference pad 108b as the user 106 raises their left arm. Because the removable haptic pads 110e-110h are on the same arm of the user 106 as the reference point pad 108b, the removable haptic pads 110e-110h move similar to the reference point pad 108b. Based on the movement of and motion data from each of the removable haptic pads 110e-110h relative to the reference point pad 108b, the location of each of the removable haptic pads 110e-110h can be determined by the haptic actuator location engine 122. In addition, when the right leg of the user 106 is moved outward, the reference point pad 108c will move in a movement that is known to the system (e.g., part of a calibration move) or the system can determine the movement based on the known location of the reference point pad 108c, the user's right leg, and the change in location of the reference pad 108c as the user 106 moves their right leg. Because the removable haptic pads 110i-110l are on the same leg of the user 106 as the reference point pad 108c, the removable haptic pads 110i-110l move similar to the reference point pad 108c. Based on the movement of and motion data from each of the removable haptic pads 110i-110l relative to the reference point pad 108c, the location of each of the removable haptic pads 110i-110l can be determined by the haptic actuator location engine 122. Further, when the left leg of the user 106 is moved outward, the reference point pad 108d will move in a movement that is known to the system (e.g., part of a calibration move) or the system can determine the movement based on the known location of the reference point pad 108d, the user's left leg, and the change in location of the reference pad 108d as the user 106 moves their left leg. Because the removable haptic pads 110m-110p are on the same leg of the user 106 as the reference point pad 108d, the removable haptic pads 110m-110p move similar to the reference point pad 108d. Based on the movement of and motion data from each of the removable haptic pads 110m-110p relative to the reference point pad 108d, the location of each of the removable haptic pads 110m-110p can be determined by the haptic actuator location engine 122. The removable haptic pads 110q-110t may not move or only slight move when the right arm and left arm of the user 106 are raised and the right leg and the left leg of the user are moved outward. The position of the removable haptic pads 110q-110t can still be determined because the distance from one or more of the reference point pads 108a-108d will have changed as the user moved their arms and legs and the change in distance between the removable haptic pads 110q-110t and the one or more of the reference point pads 108a-108d can be used to determine the position of the removable haptic pads 110q-110t on the user 106.

In addition, as illustrated in FIG. 1C, when the user 106 bends over, the reference point pad 108b will move in a movement that is known to the system (e.g., part of a calibration move) or the system can determine the movement based on the known location of the reference point pad 108b. Because the removable haptic pads 110e-110h are on the same arm of the user 106 as the reference point pad 108b, the removable haptic pads 110e-110h move in a similar way as the reference point pad 108b. Based on the movement of each of the removable haptic pads 110e-110h relative to the reference point pad 108b, the location of each of the removable haptic pads 110e-110h can be determined by the haptic actuator location engine 122.

The removable haptic pads 110a-110t can be repositioned, removed, and/or new removable haptic pads can be added to the user 106 and the location of each of the repositioned, removed, and/or added removable haptic pads can be determined by the haptic actuator location engine 122. More specifically, in some examples, a feature set of each of the repositioned, removed, and/or added removable haptic pads can be determined for known user actions. The vector differences of the feature sets are used to determine the relative positioning of each of the repositioned, removed, and/or added removable haptic pads on the user 106 with respect to the reference point pads 108a-108d and/or previously mapped removable haptic pads 110. The system knows if a removable haptic pad 110 is added or removed because each of the removable haptic pads 110 in the system are communicating with the electronic device 102, a reference point pad, and/or another removable haptic pad 110.

In an example, each of the reference point pads 108a-108d includes an accelerometer and each of the removable haptic pads 110a-110t also includes an accelerometer. Motion data from the accelerometer in each of the reference point pads 108a-108d and each of the removable haptic pads 110a-110t can be communicated to the haptic actuator location engine 122. In a specific example, using the accelerometer data, the position of each of the removable haptic pads 110a-110t can be determined using a virtual mapping of the acceleration data from each of the reference point pads 108a-108d and each of the removable haptic pads 110a-110t to identify the nature of the movement of each of the removable haptic pads 110a-110t and with respect to the reference point pads 108a-108d.

More specifically, using the accelerometer data, multi-dimension spaces for each of the reference point pads 108a-108d can be created. In each of the multi-dimensional spaces, one of the reference point pads 108a-108d can be the origin and the difference of the motion of each of the removable haptic pads 110a-110t with respect to the reference point pad origin can indicate the distance each of the removable haptic pads 110a-110t is from the specific reference point pad that is the origin. In some examples, if one of the reference point pads 108a-108d is the origin, the system may not need specific calibration moves or specific training motions to create the multi-dimensional space and determine the distance each of the removable haptic pads 110a-110t from the specific reference point pad that is the origin.

In a specific example, principal component analysis (PCA) can be used to virtually map the acceleration data from each of the reference point pads 108a-108d and each of the removable haptic pads 110a-110t. PCA includes the process of computing principal components and using the principal components to perform a change of basis on the data. Using PCA, a vector space is identified and the acceleration data from each of the reference point pads 108a-108d and each of the removable haptic pads 110a-110t is represented as a point in the vector space. The origin of the vector space can be the center of gravity of the user 106, a specific reference point pad 108, or some other center point. The location of the points in the vector space that represent the removable haptic pads 110a-110t in relation to the location of the points in the vector space that represent one or more of the reference point pads 108a-108d can indicate the distance of each of the removable haptic pads 110a-110t from one or more of the reference point pads 108a-108d. Because the location of one or more of the reference point pads 108a-108d on the user 106 is known, the location of each of the removable haptic pads 110a-110t on the user 106 can be determined using the distance of each of the removable haptic pads 110a-110t from one or more of the reference point pads 108a-108d. It should be noted that other means of determining the distance of each of the removable haptic pads 110a-110t from one or more of the reference point pads 108a-108d may be used (e.g., independent component analysis (ICA)) and PCA is only used as an illustrative example.

It is to be understood that other embodiments may be utilized and structural changes may be made without departing from the scope of the present disclosure. Substantial flexibility is provided in that any suitable arrangements and configuration may be provided without departing from the teachings of the present disclosure.

For purposes of illustrating certain example techniques, the following foundational information may be viewed as a basis from which the present disclosure may be properly explained. End users have more media and communications choices than ever before. A number of prominent technological trends are currently afoot (e.g., more computing elements, more online video services, more Internet traffic, more complex processing, etc.), and these trends are changing the expected performance of devices as devices and systems are expected to increase performance and function. One current trend is VR. VR is a simulated experience that can be similar to or completely different from the real world. Applications of VR include entertainment, video games, education, medical training, military training, business applications, virtual meetings, and other applications.

Most VR systems use either virtual reality headsets or multi-projected environments to generate realistic images, sounds and other sensations that simulate a user's physical presence in a virtual environment. A person using VR equipment is able to look around the artificial world, move around in the artificial world, and/or interact with virtual features or items. The effect is commonly created by VR headsets consisting of a head-mounted display with a small screen in front of the eyes, but can also be created through specially designed rooms with multiple large screens.

The VR simulated environments seek to provide a user with an immersive experience that may simulate experiences from the real world. Simulated environments may be virtual reality, augmented realty, or mixed reality. VR simulated environments typically incorporate auditory and video feedback, and more and more systems allow other types of sensory and force feedback through haptic technology. Haptic technology, also known as kinaesthetic communication or 3D touch,¹ refers to any technology that can create an experience of touch by applying forces, vibrations, or motions to the user. Haptics are gaining widespread acceptance as a key part of VR systems, adding the sense of touch to previously visual-only interfaces.

Typically, a haptic actuator is used to create the haptic or touch experience in a VR environment. The haptic actuator is often employed to provide mechanical feedback to a user. A haptic actuator may be referred to as a device used for haptic or kinesthetic communication that recreates the sense of touch by applying forces, vibrations, or motions to the user to provide the haptic feedback to the user. The haptic feedback to the user can be used to assist in the creation of virtual objects in a computer simulation, to control virtual objects, to enhance the remote control of machines and devices, and to create other types of sensory and force feedback. The haptic devices may incorporate tactile sensors that measure forces exerted by the user on the interface.

To provide haptic feedback to the user, a garment that includes haptic actuators is worn by the user. Currently, most haptic systems include full-body or torso haptic vests or haptic suits to allow users to feel a sense of touch, especially for explosions and bullet impacts. A haptic suit (also known as tactile suit, gaming suit or haptic vest) is a wearable garment that provides haptic feedback to the body of the user. Haptic feedback provides immersive experience to gaming environments, especially VR and AR gaming environments. Haptic feedback must be accurate to the position on the body of the user, and hence the system should know the accurate position of the haptics actuators on the user.

Today, haptic actuators are integrated into wearable form factors such as vests or suits at fixed positions known by the system controlling the simulated environment. The fixed positions of these actuators are passed to the application using a configuration file or some data structure. However, a haptic actuator with a fixed location on the wearable article limits the haptic feedback that can be provided to the user. For example, a haptic actuator with a fixed location may be useful for one simulated environment, but not a second simulated environment. For fixed position haptics, the user is not allowed to change the positions of the actuators. As a result, for each application, the user is bound to the fixed positions of the actuators in the wearable form factors or garments. What is needed is a system that can allow for haptic actuators that can be added to, moved, or removed from a system and for the system to be able to determine the position of the haptic actuators.

A VR system, as outlined in FIGS. 1A-1C, can resolve these issues (and others). In an example, one or more individual haptic actuator pads (e.g., removable haptic pads 110) can be added to, moved, or removed from the VR system and the VR system can determine the position of the individual haptic actuator pads on the user's body without direct input from the user regarding the position of each individual haptic actuator pad. The user can add, move, or remove the individual haptic actuator pads based on the user's convenience and comfort and the user is not bound by fixed location based haptic feedback. The system also allows real time position changes of the individual haptic blocks as well as for the addition of new haptic blocks in real time. The number and position of the individual haptic actuator pads can be identified by the system for more immersive haptic feedback. In a specific example, each individual haptic actuator pad has an accelerometer, the output of which is analyzed during movement of the user. A virtual map of the possible positions of each individual haptic actuator pad is created and based on the user's movement, the position of each individual haptic actuator pad relative to one or more reference point pads can be determined.

The individual haptic actuator pads are individual devices that are paired with a VR engine (e.g., VR engine 118) using a communication engine (e.g., communication engine 120) to provide haptic feedback to the user while the user is engaged with the VR environment. Using sensor motion data from each of the individual haptic actuator pads and the one or more reference point pads, a haptic actuator location engine (e.g., haptic actuator location engine 122) can determine a position of each individual haptic actuator pad relative to the one or more reference point pads and virtually map the position of each of the individual haptic actuator pads on the body of the user. More specifically, with accelerometers integrated into each of the individual haptic actuator pads, each of the individual haptic actuator pads can sense the movement of each of the individual haptic actuator pads due to the part of the body that is moving (or not moving). The relative motion of each individual haptic actuator pads is analyzed with respect to a reference point and/or each other and a map of the location of each individual haptic actuator pad is created for the user. For example, the haptic actuator locator engine can determine the position of each individual haptic actuator pad on the user and allow the VR engine to drive the appropriate haptic response when required.

In one example, to determine the position of each individual haptic actuator pad on the user's body, a feature set for each individual haptic actuator pad can be created relative to known reference movements. These spaces are created such that each point in the space represents an individual haptic actuator pad. Vector spaces can be created for each reference point movement or for a combination of movements for one or more reference points. Once the reference point representations are formed in the vector space, the non-reference points for the individual haptic actuator pads are included and mapped on the user's body using vector differences between the respective reference points and the non-reference points for the individual haptic actuator pads. In some examples, machine learning/artificial intelligence algorithms can be used to help determine the position of each individual haptic actuator pad on the user.

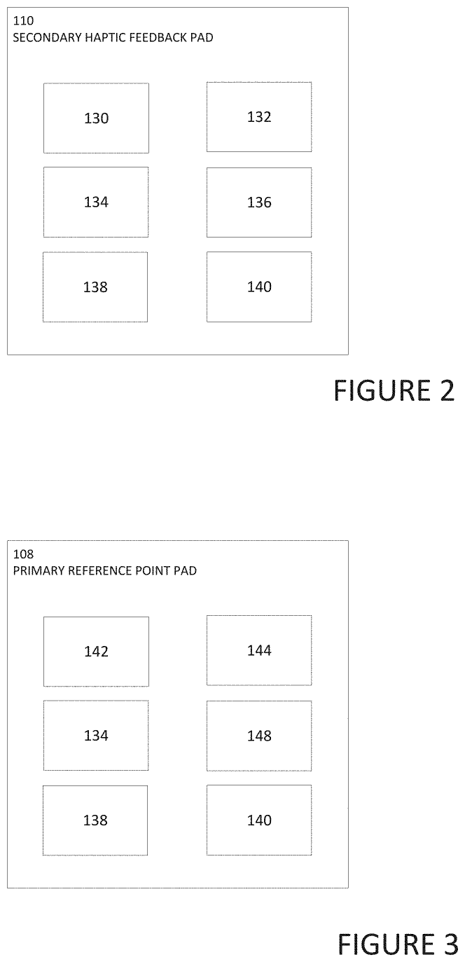

Turning to FIG. 2, FIG. 2 is a simplified block diagram of the removable haptic pad 110, in accordance with an embodiment of the present disclosure. In an example, the removable haptic pad 110 can include memory 130, one or more processors 132, one or more sensors 134, a communication engine 136, a haptic mechanism 138, and a user attachment mechanism 140.

The one or more sensors 134 can include an accelerometer, a gyroscope, and/or some other sensor that can help detect movement of the removable haptic pad 110. The one or more sensors 134 collect and/or determine motion data that can be communicated to a haptic actuator location engine (e.g., the haptic actuator location engine 122). The communication engine 136 can allow for wireless communication (e.g., WiFi, Bluetooth, etc.) or wired communication. In an example, the communication engine 136 can communicate data to and receive data from the communication engine 120 in the electronic device 102 (not shown). In another example, the communication engine 136 can communicate data to and receive data from the reference point pad 108. In yet another example, the communication engine 136 can communicate data to and receive data from other removable haptic pads (e.g., a communication engine 136 in the removable haptic pad 110a can communicate with a communication engine 136 in the removable haptic pad 110b).

The haptic mechanism 138 can provide haptic feedback to the user. For example, the haptic mechanism 138 may be an actuator that creates a vibration or haptic effect, an electrotactile mechanism that creates an electrical impulse, a thermal mechanism that creates a hot or cold sensation, or some other type of mechanism that can provide haptic feedback to the user. The user attachment mechanism 140 can be configured to removably attach or couple the removable haptic pad 110 to the user or an article (e.g., haptic suit, vest, sleeve, etc.) that can be worn by the user. The user attachment mechanism 140 may be a hook and loop faster, snap(s), zipper(s), button(s), magnet(s), adhesive, or some other type of mechanism that can removably attach or couple the removable haptic pad 110 to the user or a wearable article that can be worn by the user. In an example, the user attachment mechanism 140 may be a strap that is wrapped around a part of the user's body (e.g., arm, leg, or chest). In another example, the user attachment mechanism 140 may be a removable one time use attachment mechanism that is replaced after the one-time use. In a specific example of one-time use, the user attachment mechanism 140 may need to be broken to remove the removable haptic pad 110 after it has been attached (e.g., a zip tie).

Turning to FIG. 3, FIG. 3 is a simplified block diagram of the reference point pad 108, in accordance with an embodiment of the present disclosure. In an example, the reference point pad 108 can include memory 142, one or more processors 144, one or more sensors 134, a communication engine 148, the haptic mechanism 138, and the user attachment mechanism 140. In some examples, the reference point pad 108 does not include the haptic mechanism 138.

The communication engine 148 can allow for wireless communication (e.g., WiFi, Bluetooth, etc.) or wired communication. In an example, the communication engine 148 can communicate data to and receive data from the communication engine 120 in the electronic device 102 (not shown). In another example, the communication engine 148 can communicate data to and receive data from each of the plurality of removable haptic pads 110. In yet another example, the communication engine 148 can communicate data to and receive data from other reference point pads 108 (e.g., a communication engine 148 in the reference point pad 108a can communicate with a communication engine 148 in the reference point pad 108b).

In some examples, the user attachment mechanism 140 for the reference point pad 108 is different than the user attachment mechanism 140 for the removable haptic pad 110. More specifically, because the reference point pad 108 acts as a reference point, the reference point pad 108 needs to be securely fastened or coupled to the user or a wearable article that can be worn by the user while the removable haptic pad 110 can be relatively easily removed and repositioned or removed.

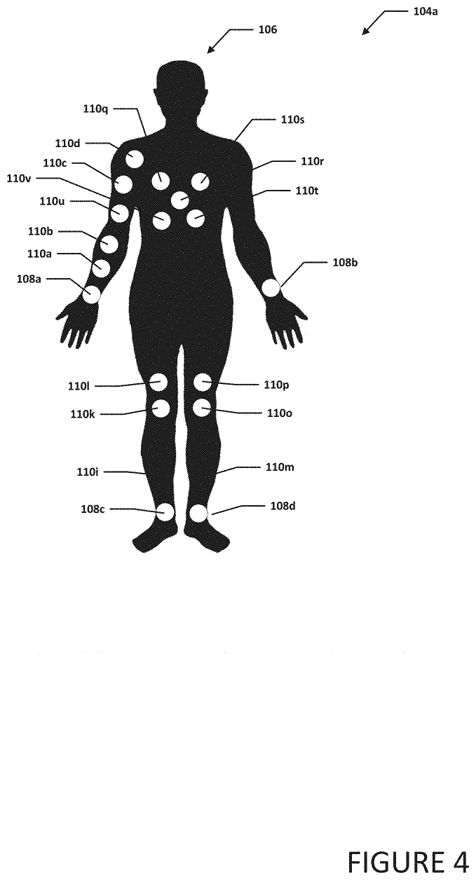

Turning to FIG. 4, FIG. 4 is a simplified block diagram of the haptic system 104a. The haptic system 104a can include the one or more reference point pads 108 and the one or more removable haptic pads 110. For example, as illustrated in FIG. 4, the haptic system 104a includes four (4) reference point pads 108a-108d and fourteen (14) removable haptic pads 110a-110p. The number and configuration of the removable haptic pads 110 in the haptic system 104a is different than the number and configuration of the removable haptic pads 110 in the haptic system 104 illustrated in FIGS. 1A-1C.

More specifically, the haptic system 104 illustrated in FIGS. 1A-1C shows four (4) of the removable haptic pads 110a-110d along the right arm of the user 106 while the haptic system 104a shows five (5) of the removable haptic pads 110a-110d and 110u along the right arm of the user 106. In an example, the removable haptic pad 110u may have been added by the user to give the user increase feedback on the right arm. To accommodate the addition of the removable haptic pad 110u on the right arm, one or more of the removable haptic pads 110a-110d may have been moved from the position illustrated in FIGS. 1A-1C to a position that is more comfortable for the user, to a position where the user wants to focus the feedback, and/or to accommodate the addition of the removable haptic pad 110u. Also, the haptic system 104 illustrated in FIGS. 1A-1C shows four (4) of the removable haptic pads 110e-110h along the left arm of the user 106 while the haptic system 104a does not show any of the removable haptic pads 110 on the left arm of the user 106. In some examples, the VR environment that the user 106 engaged in while wearing the haptic system 104a may not have any feedback to the left arm of the user 106 so the user 106 decided to not include any of the removable haptic pads 110 on the left arm. In another example, the user 106 may have injured their left arm or have some pre-existing condition where feedback on the left harm hurts or is uncomfortable for the user 106 so the user 106 either does not add any of the removable haptic pads 110 to the left arm or removes them if they were previously present on the left arm of the user 106.

In addition, the haptic system 104 illustrated in FIGS. 1A-1C shows four (4) of the removable haptic pads 110q-110t in an approximate line around an approximate middle area of the chest of the user 106 while the haptic system 104a illustrated in FIG. 4 shows five (5) of the removable haptic pads 110q-110t and 110v in an approximate middle area of the chest of the user 106 in an approximate “X” configuration. In some examples, the user 106 may want addition feedback in the chest area while engaging in the VR environment. Also, the haptic system 104 illustrated in FIGS. 1A-1C shows four (4) of the removable haptic pads 110i-110l along the right leg of the user 106 and four (4) of the removable haptic pads 110m-110p along the left leg of the user 106 while the haptic system 104a illustrated in FIG. 4 shows two (2) of the removable haptic pads 110k and 110l on the right leg of the user 106 and two (2) of the removable haptic pads 110o and 110p on the left leg of the user. In some examples, the VR environment that the user 106 engaged in while wearing the haptic system 104a may not have any feedback to the lower portion of the leg (e.g., calf area) so the user 106 decided to not include any of the removable haptic pads 110 on the lower right leg or lower left leg. In another example, the user 106 may find the feedback on the lower right leg and lower left leg uncomfortable for the user 106 or a distraction to the user 106 so the user 106 either does not add the removable haptic pads 110 to the lower right leg and lower left leg or removes them if they were previously present.

The location of each of the repositioned, removed, and/or added removable haptic pads 110 can be determined by the haptic actuator location engine 122. More specifically, in some examples, a feature set of each of the repositioned, removed, and/or added removable haptic pads 110 can be determined for known user actions. Vector differences of feature sets can be used to determine the relative positioning of each of the repositioned, removed, and/or added removable haptic pads 110 on the user 106 with respect to the reference point pads 108a-108d and/or previously mapped removable haptic pads 110.

As shown by the number and configuration of the removable haptic pads 110 in the haptic system 104a illustrated in FIG. 4 as compared to the number and configuration of the removable haptic pads 110 in haptic system 104 illustrated in FIGS. 1A-1C, different numbers and configurations of the removable haptic pads 110 can be used, depending on the user's preference. In some examples, the individual removable haptic pads 110 are attached or secured to the user 106 using straps or adhesive and the removable haptic pads 110 may go over the user's cloths or be in direct contact with the user's skin. In other examples, the removable haptic pads 110 are attached or secured to a haptic garment such as a haptic suit, vest, sleeves, etc. and the user 106 wears the haptic garment.

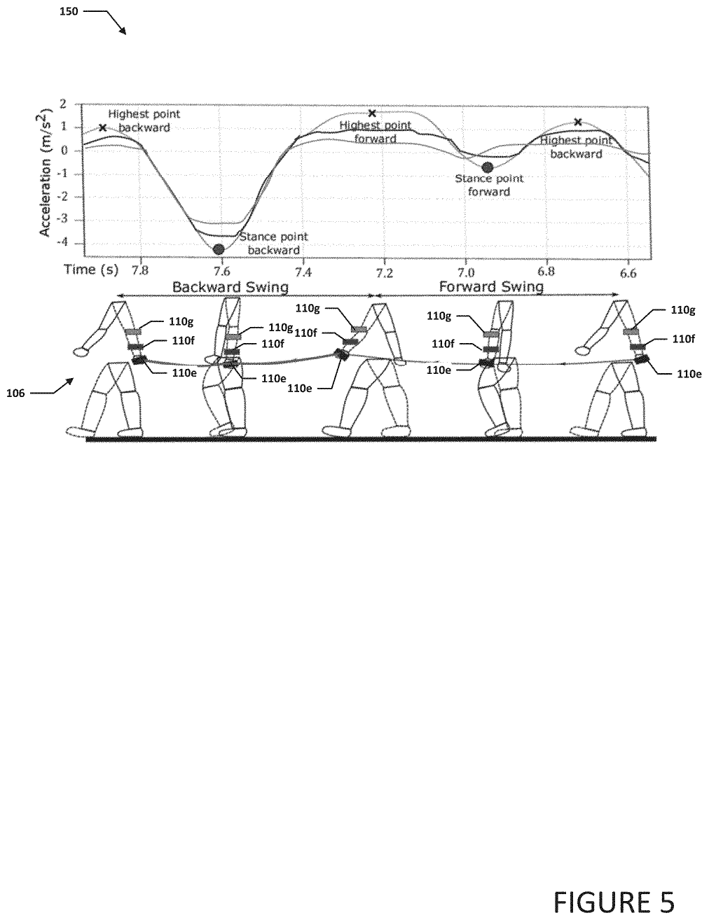

Turning to FIG. 5, FIG. 5 is a simplified block diagram illustrating example details of the VR system 100. As illustrated in FIG. 5, a wireframe representation of the user 106 can include the reference point pad 108b and the removable haptic pads 110f and 110g on the user's left arm. The reference point pad 108b and the removable haptic pads 110f and 110g can each include an accelerometer and the output from each accelerometer can be shown in a graph 150. The graph 150 can record the readings from the accelerometers in the reference point pad 108b and the removable haptic pads 110f and 110g over time as the user 106 walks.

As illustrated in the graph 150, the user 106 walking results in differences in the output of the accelerometers due to the amount of swing of the arms of the user 106 and the movement of the accelerometers. Because the location of the reference point pad 108b is known (e.g., during the initial setup, through calibration moves, etc.), the haptic actuator location engine 122 (not shown) can determine the location of the removable haptic pads 110f and 110g using the change in distance of the removable haptic pads 110f and 110g with respect to the reference point pad 108b.

In a specific example, during an initial calibration phase, the user 106 is required to perform a standard set of actions in order to obtain movement reference signals from the reference point pad 108b and the removable haptic pads 110f and 110g. Feature vectors are extracted from these signals for each reference movement. The feature vector difference, or vector distance, between the output of the removable haptic pads 110f and 110g in relation to the reference point pad 108b can be used to map the location of the removable haptic pads 110f and 110g to their respective positions on the user 106.

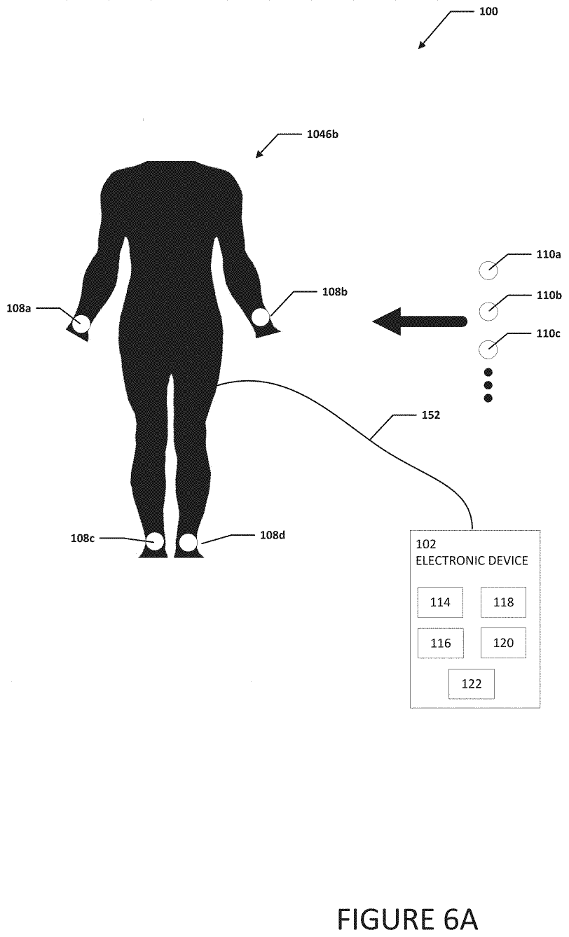

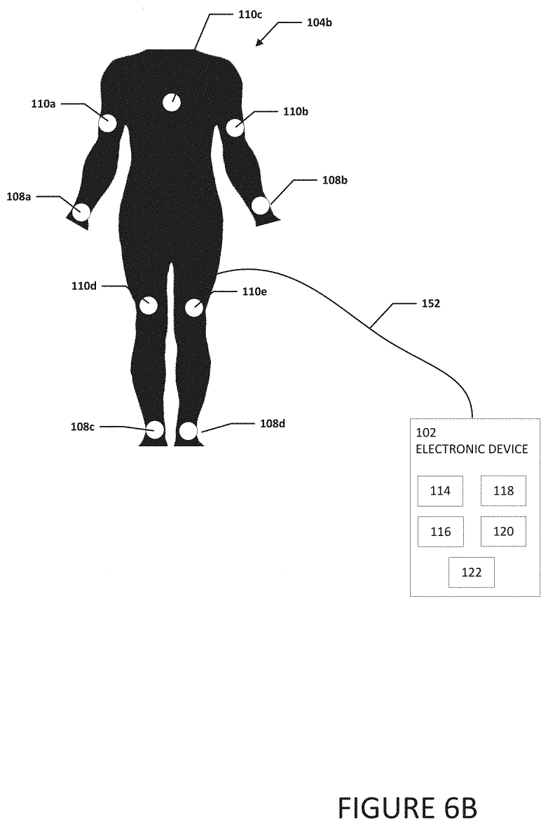

Turning to FIGS. 6A and 6B, FIGS. 6A and 6B are simplified block diagrams of haptic system 104b. The haptic system 104b can be a haptic suit worn by a user (e.g., the user 106, not shown). In some examples, the haptic system 104b does not include any hands or feet coverings. In other examples, the haptic system 104b can include integrated gloves that extend over the hands of the user and integrated feet covering that extend over the feet of the user. The haptic system 104b can be hard wired to electronic device 102 or can be in wireless communication with electronic device 102. For example, in FIGS. 6A and 6B, the haptic system 104b is in communication with the electronic device 102 using wired connection 152. The electronic device 102 can include memory 114, one or more processors 116, the VR engine 118, the communication engine 120, and the haptic actuator location engine 122.

The haptic system 104b can include the one or more reference point pads 108. In an example, the one or more reference point pads 108 can be integrated into the haptic system 104b (e.g., not removable). As illustrated in FIGS. 6A and 6B, the haptic system 104b includes the reference point pads 108a-108d. In an example, each of the reference point pads 108a-108d can independently communicate with the electronic device 102. In another example, one of the reference point pads 108a-108d is a communication gateway and all the other reference point pads communicate with the communication gateway reference point pad and the communication gateway reference point pad communicates with the electronic device 102. More specifically, if the reference point pad 108b is the communication gateway reference point pad, then the reference point pads 108a, 108c and 108d communicate with the reference point pad 108b and the reference point pad 108b communicates with the electronic device 102. The communication between the reference point pads 108a-108d can be wired or wireless communications. Also, the communication between the reference point pads 108a-108d and the electronic device 102 or the communication gateway reference point pad, if present, can be wired or wireless communication.

The haptic system 104b can also include one or more removable haptic pads 110. The one or more removable haptic pads 110 can be added to the haptic system 104b and configured depending on user preference and design constrains. For example, as illustrated in FIG. 6B, five (5) of the removable haptic pads 110a-110e were added to the haptic system 104b illustrated in FIG. 6A. The number and location of each of the removable haptic pads 110a-110e illustrated in FIG. 6B is for illustration purposes only and more or fewer of the removable haptic pads 110 can be added in different locations and configurations, depending on user preference and design constrains. In an example, each of the removable haptic pads 110a-110e can independently communicate with the electronic device 102. In another example, one of the reference point pads 108a-108d is a communication gateway for a specific group of removable haptic pads 110. For example, the reference point pad 108a may be a communication gateway for the removable haptic pads 110a and 110c, the reference point pad 108b may be a communication gateway for the removable haptic pad 110b, the reference point pad 108c may be a communication gateway for the removable haptic pad 110d, and the reference point pad 108d may be a communication gateway for the removable haptic pad 110e. In another example, the reference point pad 108a may be a communication gateway for the removable haptic pads 110a, 110b and 110c, and the reference point pad 108c may be a communication gateway for the removable haptic pads 110d and 110e. In yet another example, the reference point pad 108b may be a communication gateway for the removable haptic pads 110a-110e. The communication between the reference point pads 108a-108d and the removable haptic pads 110a-110e can be wired or wireless communications. Also, the communication between the reference point pads 108a-108d, the removable haptic pads 110a-110e, and the electronic device 102 can be wired or wireless communication.

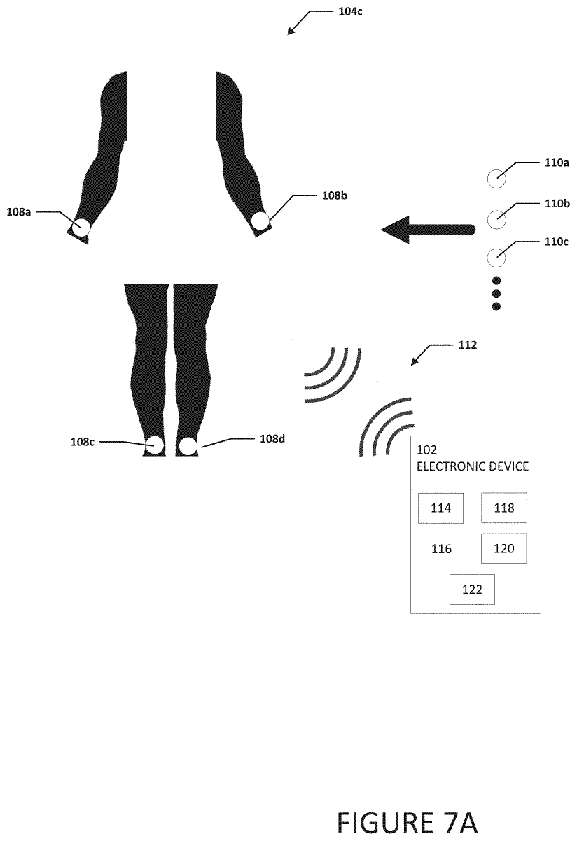

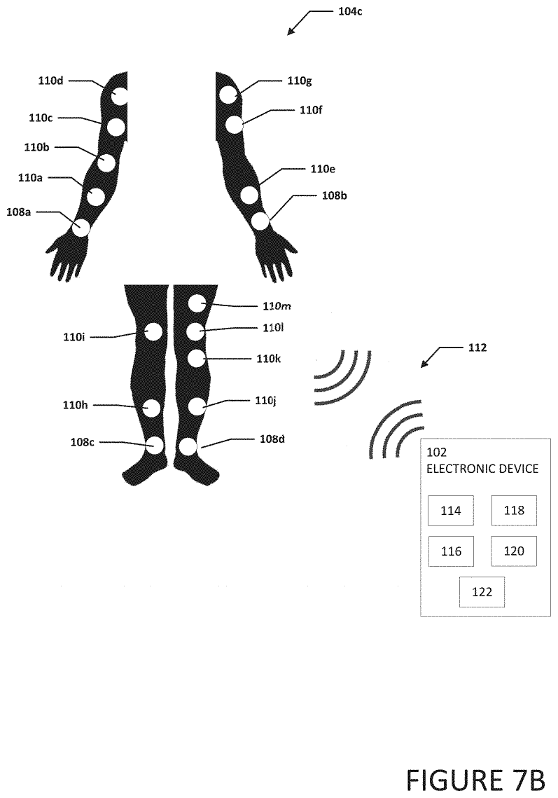

Turning to FIGS. 7A and 7B, FIGS. 7A and 7B are simplified block diagrams of haptic system 104c. Haptic system 104c can be one or more haptic sleeves that can be worn by a user (e.g., the user 106, not shown) where the sleeves slide over the arms and legs of the user 106. In some examples, the haptic system 104c does not include any hand or feet coverings. In other examples, the haptic system 104c can include integrated gloves that extend over the hands of the user and integrated feet covering that extend over the feet of the user. The haptic system 104c can be hard wired to the electronic device 102 or can be in wireless communication with the electronic device 102. For example, in FIGS. 7A and 7B, the haptic system 104c is in communication with the electronic device 102 using the wireless connection 112. The electronic device 102 can include memory 114, one or more processors 116, the VR engine 118, the communication engine 120, and the haptic actuator location engine 122.

The haptic system 104b can include the one or more reference point pads 108 and the one or more removable haptic pads 110. For example, as illustrated in FIGS. 7A and 7B, the haptic system 104 includes four (4) of the reference point pads 108a-108d. The one or more removable haptic pads 110 can be added and configured depending on user preference and design constrains. For example, as illustrated in FIG. 7B, thirteen (13) of the removable haptic pads 110a-110m were added to the haptic system 104c illustrated in FIG. 7A. The number and location of each of the removable haptic pads 110a-110m illustrated in FIG. 7B is for illustration purposes only and more or fewer of the removable haptic pads 110 can be added in different locations and configurations, depending on user preference and design constrains. Note that the number and configuration of the removable haptic pads 110 is not symmetrical between the right arm sleeve, the left arm sleeve, the right leg sleeve, and the left leg sleeve.

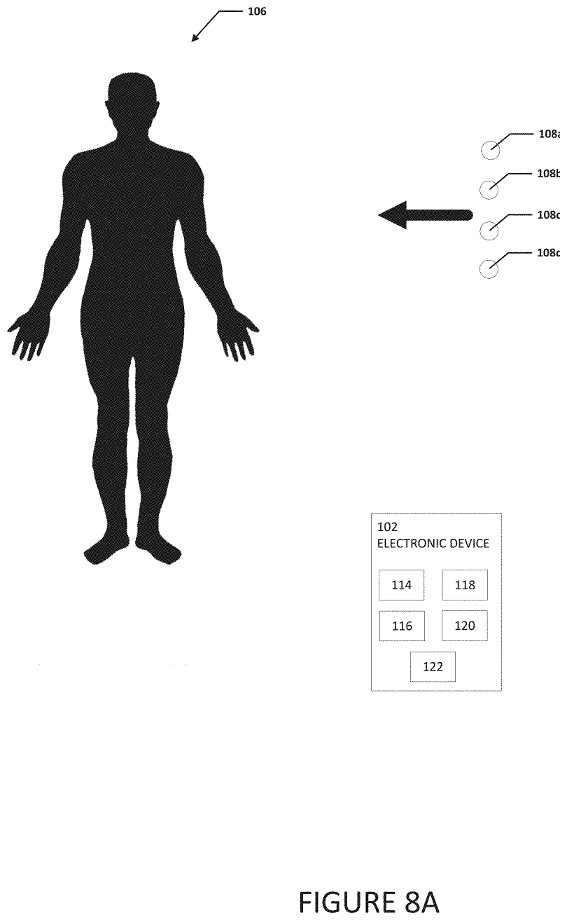

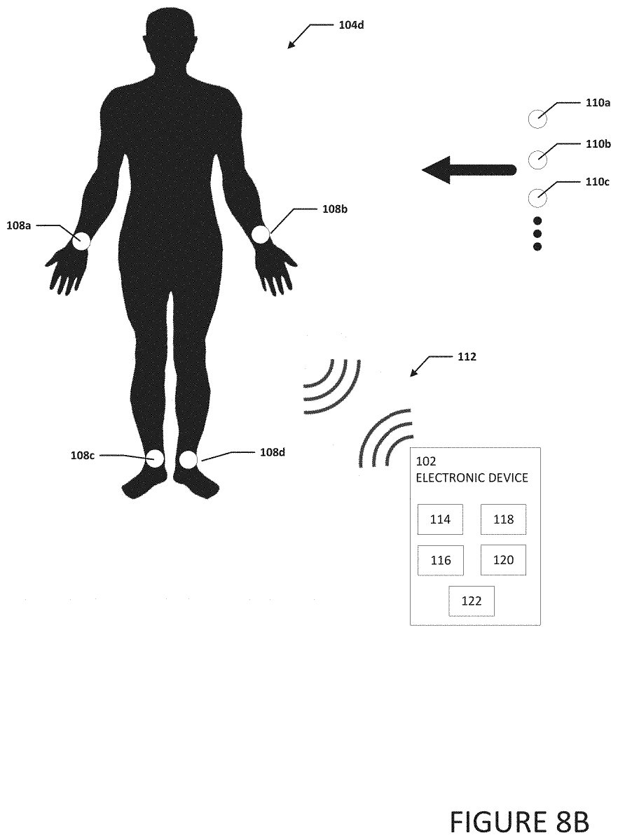

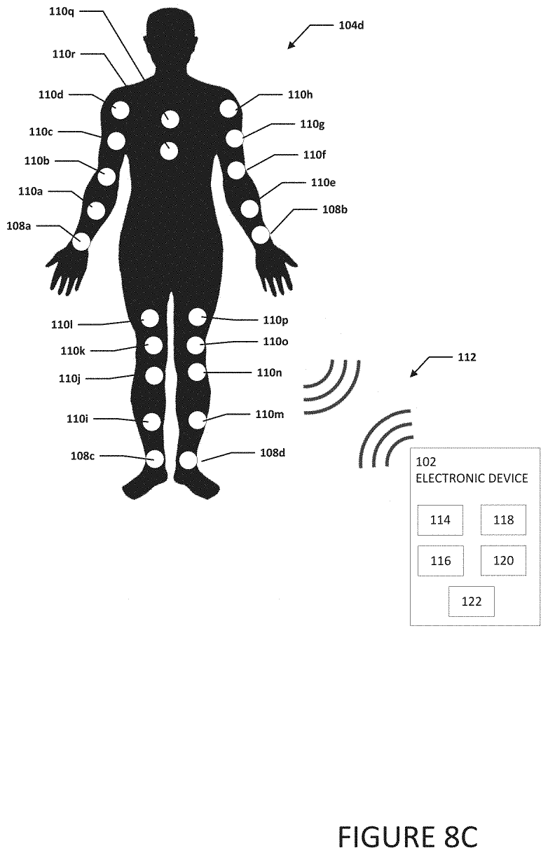

Turning to FIG. 8A, FIG. 8A illustrates the user 106 without any portion of a haptic system on the user 106. In an example, the user 106 can locate one or more of the reference point pads 108 and attach or couple the one or more reference point pads 108 to the user 106 and start to create or build the haptic system 104. Each of the one or more reference point pads 108 can be individual reference point pads and not be attached or coupled to a haptic suit (as illustrated in FIGS. 6A and 6B) or haptic sleeves (as illustrated in FIGS. 7A and 7B). The electronic device 102 can include memory 114, one or more processors 116, the VR engine 118, the communication engine 120, and the haptic actuator location engine 122.

Turning to FIGS. 8B and 8C, FIGS. 8B and 8C are simplified block diagrams of haptic system 104d. The haptic system 104d can be wired to the electronic device 102 or can be in wireless communication with the electronic device 102. For example, in FIGS. 8B and 8C, the haptic system 104d is in communication with the electronic device 102 using the wireless connection 112.

In an example, the haptic system 104d can include four (4) of the reference point pads 108a-108d and one or more of the removable haptic pads 110. In an example, the reference point pads 108a-108d should be located at VR system designated reference point areas of the user 106. For example, the reference point pad 108a can be located on the right wrist area of the user 106, the reference point pad 108b can be located on the left wrist area of the user 106, the reference point pad 108c can be located on the right ankle area of the user 106, and the reference point pad 108d can be located on the left ankle area of the user 106. In other examples, the user 106 is free to attach or couple the reference point pads 108a-108d on different locations of the user 106 (preferable one on each limb) and the haptic actuator location engine 122 can use the reference point pads 108a-108d to identify the location of the one or more removable haptic pads 110 relative to the reference point pads 108a-108d.

The one or more removable haptic pads 110 can be added and configured depending on user preference and design constrains. For example, as illustrated in FIG. 8C, eighteen (18) of the removable haptic pads 110a-110p were added to the haptic system 104c illustrated in FIG. 8B. The number and location of each of the removable haptic pads 110a-110p illustrated in FIG. 8C is for illustration purposes only and more or fewer of the removable haptic pads 110 can be added in different locations and configurations, depending on user preference and design constrains.

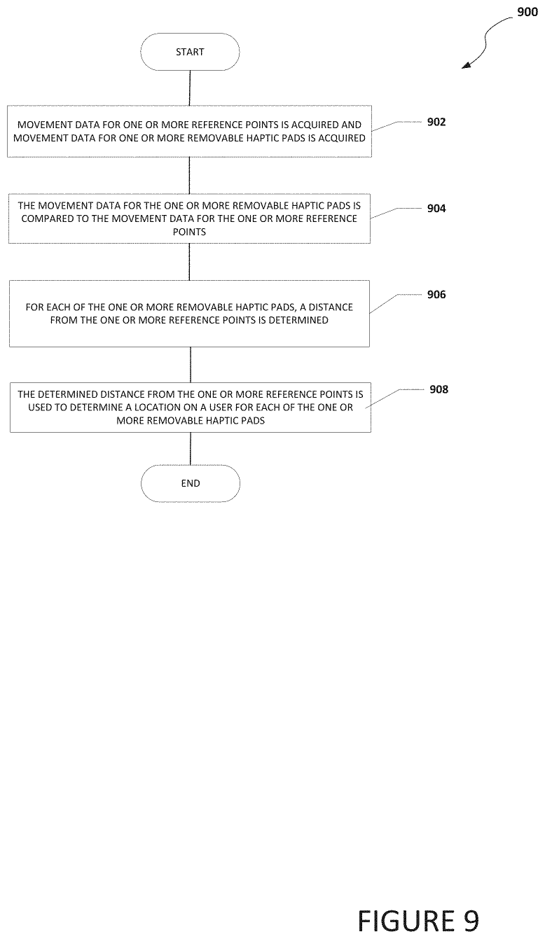

Turning to FIG. 9, FIG. 9 is an example flowchart illustrating possible operations of a flow 900 that may be associated with haptic actuator location detection, in accordance with an embodiment of the present disclosure. In an embodiment, one or more operations of flow 900 may be performed by the VR engine 118, the communication engine 120, the haptic actuator location engine 122, the one or more sensors 134, the communication engine 136, the haptic mechanism 138, and the user attachment mechanism 140. At 902, movement data for one or more reference points is acquired and movement data for one or more removable haptic pads is acquired. At 904, the movement data for the one or more removable haptic pads is compared to the movement data for the one or more reference points. At 906, for each of the one or more removable haptic pads, a distance from the one or more reference points is determined. At 908, the determined distance from the one or more reference points is used to determine a location on a user for each of the one or more removable haptic pads.

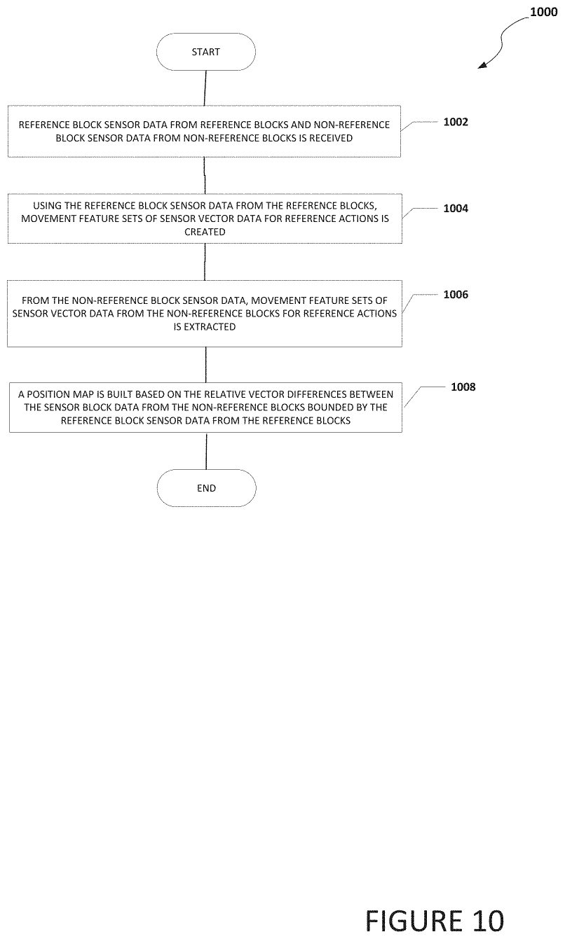

Turning to FIG. 10, FIG. 10 is an example flowchart illustrating possible operations of a flow 1000 that may be associated with haptic actuator location detection, in accordance with an embodiment of the present disclosure. In an embodiment, one or more operations of flow 1000 may be performed by the VR engine 118, the communication engine 120, the haptic actuator location engine 122, the one or more sensors 134, the communication engine 136, the haptic mechanism 138, and the user attachment mechanism 140. At 1002, reference block sensor data from reference blocks and non-reference block sensor data from non-reference blocks is received. For example, sensor data from the reference point pads 108 (the reference blocks) and from the removable haptic pads 110 (the non-reference blocks) can be received by the haptic actuator location engine 122. The sensor data can be from the one or more sensors 134 in each of the reference point pads 108 and the removable haptic pads 110. More specifically, the sensor data can be acceleration data from an accelerometer in each of the reference point pads 108 and the removable haptic pads 110. At 1004, using the reference blocks sensor data from the reference blocks, movement feature sets of sensor vector data for reference actions are created. At 1006, from the non-reference block sensor data, movement feature sets of sensor vector data from the non-reference blocks for reference actions is extracted. At 1008, a position map is built based on the relative vector differences between the sensor block data from the non-reference blocks bounded by the reference block sensor data from the reference blocks.

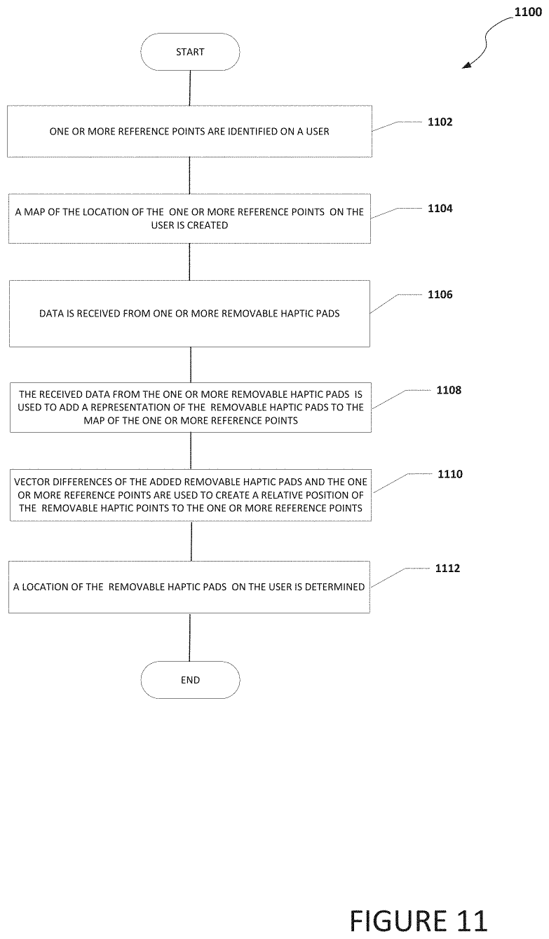

Turning to FIG. 11, FIG. 11 is an example flowchart illustrating possible operations of a flow 1100 that may be associated with haptic actuator location detection, in accordance with an embodiment of the present disclosure. In an embodiment, one or more operations of flow 1100 may be performed by the VR engine 118, the communication engine 120, the haptic actuator location engine 122, the one or more sensors 134, the communication engine 136, the haptic mechanism 138, and the user attachment mechanism 140. At 1102, one or more reference points are identified on a user. At 1104, a map of the location of the one or more reference points on the user is created. For example, based on the movements of the user 106, the location of the one or more reference point pads 108 can be determined. At 1106, data is received from one or more removable haptic pads. At 1108, the received data from the one or more removable haptic pads is used to add a representation of the removable haptic pads to the map of the one or more reference points. At 1110, vector differences of the added representation of the removable haptic pads and the one or more reference points are used to create a relative position of the removable haptic pads relative to the one or more reference points. At 1112, a location of the removable haptic pads on the user is determined.

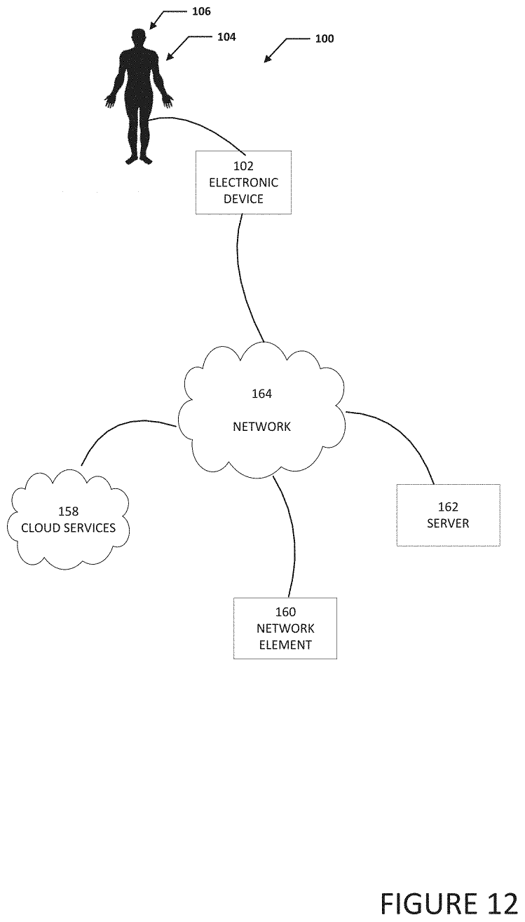

Turning to FIG. 12, FIG. 12 is a simplified block diagram of the VR system configured with haptic actuator location detection, in accordance with an embodiment of the present disclosure. In an example, the VR system 100 can include the electronic device 102 and the haptic system 104 on the user 106. The electronic device 102 may be in communication with cloud services 158, network element 160, and/or server 162 using network 164. In some examples, the electronic device 102 may be standalone devices and not connected to the network 164.

Elements of FIG. 12 may be coupled to one another through one or more interfaces employing any suitable connections (wired or wireless), which provide viable pathways for network (e.g., the network 164, etc.) communications. Additionally, any one or more of these elements of FIG. 12 may be combined or removed from the architecture based on particular configuration needs. The network 164 may include a configuration capable of transmission control protocol/Internet protocol (TCP/IP) communications for the transmission or reception of packets in a network. The electronic device 102 may also operate in conjunction with a user datagram protocol/IP (UDP/IP) or any other suitable protocol where appropriate and based on particular needs.

Turning to the network infrastructure of FIG. 12, the network 164 represents a series of points or nodes of interconnected communication paths for receiving and transmitting packets of information. The network 164 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In the network 164, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Messages through the network could be made in accordance with various network protocols, (e.g., Ethernet, Infiniband, OmniPath, etc.). Additionally, radio signal communications over a cellular network may also be provided. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks.

The electronic device 102 and the haptic system 104 may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information. Electronic device 102 may include virtual elements.

In regards to the internal structure, the electronic device 102 and the haptic system 104 can include memory elements for storing information to be used in operations. The electronic device 102 and the haptic system 104 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received could be provided in any database, register, queue, table, cache, control list, or other storage structure, all of which can be referenced at any suitable timeframe. Any such storage options may also be included within the broad term ‘memory element’ as used herein.

In certain example implementations, functions may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for operations. This includes the memory elements being able to store software, logic, code, or processor instructions that are executed to carry out operations or activities.

Additionally, the electronic device 102 and the haptic system 104 can include one or more processors that can execute software or an algorithm. In one example, the processors could transform an element or an article (e.g., data) from one state or thing to another state or thing. In another example, activities may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read-only memory (EPROM), an electrically erasable programmable read-only memory (EEPROM)) or an ASIC that includes digital logic, software, code, electronic instructions, or any suitable combination thereof. Any of the potential processing elements, modules, and machines described herein should be construed as being encompassed within the broad term ‘processor.’

Implementations of the embodiments disclosed herein may be formed or carried out on or over a substrate, such as a non-semiconductor substrate or a semiconductor substrate. In one implementation, the non-semiconductor substrate may be silicon dioxide, an inter-layer dielectric composed of silicon dioxide, silicon nitride, titanium oxide and other transition metal oxides. Although a few examples of materials from which the non-semiconducting substrate may be formed are described here, any material that may serve as a foundation upon which a non-semiconductor device may be built falls within the spirit and scope of the embodiments disclosed herein.

In another implementation, the semiconductor substrate may be a crystalline substrate formed using a bulk silicon or a silicon-on-insulator substructure. In other implementations, the semiconductor substrate may be formed using alternate materials, which may or may not be combined with silicon, that include but are not limited to germanium, indium antimonide, lead telluride, indium arsenide, indium phosphide, gallium arsenide, indium gallium arsenide, gallium antimonide, or other combinations of group III-V or group IV materials. In other examples, the substrate may be a flexible substrate including 2D materials such as graphene and molybdenum disulphide, organic materials such as pentacene, transparent oxides such as indium gallium zinc oxide poly/amorphous (low temperature of dep) III-V semiconductors and germanium/silicon, and other non-silicon flexible substrates. Although a few examples of materials from which the substrate may be formed are described here, any material that may serve as a foundation upon which a semiconductor device may be built falls within the spirit and scope of the embodiments disclosed herein.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the electronic device 102 and the haptic system 104 and their teachings are readily scalable and can accommodate a large number of components, as well as more complicated/sophisticated arrangements and configurations. Accordingly, the examples provided should not limit the scope or inhibit the broad teachings of the electronic device 102 and the haptic system 104 and as potentially applied to a myriad of other architectures. For example, the haptic system 104 and the haptic actuator location engine 122 can have applications or uses outside of a VR environment.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the electronic device 102 and the haptic system 104 has been illustrated with reference to particular elements and operations, these elements and operations may be replaced by any suitable architecture, protocols, and/or processes that achieve the intended functionality of the electronic device 102 and the haptic system 104.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

In Example A1, is an electronic device including a virtual reality engine configured to create a virtual environment for a user, a communication engine in communication with at least one reference point pad on the user, and a haptic actuator location engine to determine a position of one or more removable haptic pads on the user using sensor data from each of the one or more removable haptic pads and the at least one reference point pad.

In Example A2, the subject matter of Example A1 can optionally include where the sensor data is motion data from an accelerometer located in each of the one or more removable haptic pads and the at least one reference point pad.

In Example A3, the subject matter of any one of Examples A1-A2 can optionally include where the motion data from a calibration movement the user performs in the virtual environment.

In Example A4, the subject matter of any one of Examples A1-A3 can optionally include where the haptic actuator location engine virtually maps the position of each of the one or more removable haptic pads relative to the at least one reference point pad.

In Example A5, the subject matter of any one of Examples A1-A4 can optionally include where the haptic actuator location engine uses acceleration data from each of the one or more removable haptic pads and the at least one reference point pad to virtually map the position of each of the one or more removable haptic pads relative to the at least one reference point pad.

In Example A6, the subject matter of any one of Examples A1-A5 can optionally include where using the virtual map, a vector distance from each of the one or more removable haptic pads relative to the at least one reference point pad is used to determine the position of each of the one or more removable haptic pads on the user.

In Example A7, the subject matter of any one of Examples A1-A6 can optionally include where principal component analysis (PCA) is used to map the acceleration data from each of the one or more removable haptic pads relative to the at least one reference point pad.

In Example A8, the subject matter of any one of Examples A1-A7 can optionally include where the removable haptic pads are attached to the user using straps and the removable haptic pads provide haptic feedback to the user when the use is engaged with the virtual environment.

In Example A9, the subject matter of any one of Examples A1-A8 can optionally include where at least one of the one or more removable haptic pads is moved to a new position while the user is in the virtual environment and the haptic actuator location engine determines the new position for each of the at least one of the one or more removable haptic pads that were moved without the user having to recalibrate.

Example M1 is a method including creating a virtual environment for a user, where the virtual environment includes haptic feedback to the user, identifying that the user added one or more removable haptic pads, collecting sensor data from each of the added one or more removable haptic pads and from one or more reference point pads, and determining a location on the user where each of the one or more removable haptic pads were added.

In Example M2, the subject matter of Example M1 can optionally include where the sensor data is motion data from an accelerometer located in each of the one or more removable haptic pads and the one or more reference point pads.

In Example M3, the subject matter of any one of the Examples M1-M2 can optionally include where the motion data is from a calibration movement when the user is in the virtual environment.

In Example M4, the subject matter of any one of the Examples M1-M3 can optionally include using acceleration data from each of the one or more removable haptic pads and the one or more reference point pads to virtually map the location of each of the one or more removable haptic pads relative to the one or more reference point pads.

In Example M5, the subject matter of any one of the Examples M1-M4 can optionally include where the one or more removable haptic pads are added when the user is in the virtual environment.

Example AA1 is a virtual reality system including a virtual reality engine configured to create a virtual environment for a user, where the virtual environment includes haptic feedback to the user, a haptic system worn by the user, where the haptic system includes one or more reference point pads and one or more removable haptic pads, a communication engine in communication with at least one reference point pad on the user and the one or more removable haptic pads, and a haptic actuator location engine to determine a location of each of the one or more removable haptic pads on the user using sensor data from each of the one or more removable haptic pads and the one or more reference point pads.

In Example AA2, the subject matter of Example AA1 can optionally include where the sensor data is motion data from an accelerometer located in each of the one or more removable haptic pads and the one or more reference point pads.

In Example AA3, the subject matter of any one of Examples AA1-AA2 can optionally include where each of the reference point pads and the one or more removable haptic pads are individually attached to a user and not attached to a haptic suit or haptic vest.

In Example AA4, the subject matter of any one of Examples AA1-AA3 can optionally include where the haptic actuator location engine uses acceleration data from each of the one or more removable haptic pads and the one or more reference point pads to virtually map the location of each of the one or more removable haptic pads relative to the one or more reference point pads.

In Example AA5, the subject matter of any one of Examples AA1-AA4 can optionally include where using the virtual map, a vector distance from each of the one or more removable haptic pads relative to the one or more reference point pads is used to determine the location of each of the one or more removable haptic pads on the user.

In Example AA6, the subject matter of any one of Examples AA1-AA5 can optionally include where the one or more reference point pads includes four reference point pads with a first reference point pad located on a right wrist area of the user, a second reference point pad located on a left wrist area of the user, a third reference point pad located on a right ankle area of the user, and a fourth reference point pad located on a left ankle area of the user.

Example S1 is a system including means for creating a virtual environment for a user, where the virtual environment includes haptic feedback to the user, identifying that the user added one or more removable haptic pads, means for collecting sensor data from each of the added one or more removable haptic pads and from one or more reference point pads, and means for determining a location on the user where each of the one or more removable haptic pads were added.

In Example S2, the subject matter of Example S1 can optionally include where the sensor data is motion data from an accelerometer located in each of the one or more removable haptic pads and the one or more reference point pads.

In Example S3, the subject matter of any one of the Examples S1-S2 can optionally include where the motion data is from a calibration movement when the user is in the virtual environment.

In Example S4, the subject matter of any one of the Examples S1-S3 can optionally include means for using acceleration data from each of the one or more removable haptic pads and the one or more reference point pads to virtually map the location of each of the one or more removable haptic pads relative to the one or more reference point pads.

In Example S5, the subject matter of any one of the Examples S1-S4 can optionally include where the one or more removable haptic pads are added when the user is in the virtual environment.

In Example AAA1, is an electronic device including a virtual reality engine configured to create a virtual environment for a user, a communication engine in communication with at least one reference point pad on the user, and a haptic actuator location engine to determine a position of one or more removable haptic pads on the user using sensor data from one or more removable haptic pads and the at least one reference point pad.

In Example AAA2, the subject matter of Example AAA1 can optionally include where the sensor data is motion data from one or more sensors located in the one or more removable haptic pads and the at least one reference point pad.

In Example AAA3, the subject matter of any one of Examples AAA1-AAA2 can optionally include where the one or more sensors is an accelerometer.

In Example AAA4, the subject matter of any one of Examples AAA1-AAA3 can optionally include where the motion data is associated with a calibration movement the user performs in the virtual environment.

In Example AAA5, the subject matter of any one of Examples AAA1-AAA4 can optionally include where the haptic actuator location engine maps the position of each of the one or more removable haptic pads relative to the at least one reference point pad.

In Example AAA6, the subject matter of any one of Examples AAA1-AAA5 can optionally include where the haptic actuator location engine uses acceleration data from each of the one or more removable haptic pads and the at least one reference point pad to map the position of each of the one or more removable haptic pads relative to the at least one reference point pad.

In Example AAA7, the subject matter of any one of Examples AAA1-AAA6 can optionally include where using the map, a vector distance from each of the one or more removable haptic pads relative to the at least one reference point pad is used to determine the position of each of the one or more removable haptic pads on the user.

In Example AAA8, the subject matter of any one of Examples AAA1-AAA7 can optionally include where principal component analysis (PCA) is used to map the acceleration data from each of the one or more removable haptic pads relative to the at least one reference point pad.

In Example AAA9, the subject matter of any one of Examples AAA1-AAA8 can optionally include where the removable haptic pads are attached to the user using straps and the removable haptic pads provide haptic feedback to the user when the user is engaged with the virtual environment.

In Example AAA10, the subject matter of any one of Examples AAA1-AAA9 can optionally include where in response to determining that at least one of the one or more removable haptic pads is moved to a new position, the haptic actuator location engine determines the new position for each of the at least one of the one or more removable haptic pads that were moved without the user having to recalibrate.

Example M1 is a method including identifying the addition of one or more removable haptic pads to a user, collecting sensor data from each of the added one or more removable haptic pads and from one or more reference point pads, and determining a location on the user where each of the one or more removable haptic pads were added.

In Example M2, the subject matter of Example M1 can optionally include where the sensor data is motion data from an accelerometer located in each of the one or more removable haptic pads and the one or more reference point pads.

In Example M3, the subject matter of any one of the Examples M1-M2 can optionally include where the motion data is from a calibration movement when the user is in the virtual environment.

In Example M4, the subject matter of any one of the Examples M1-M3 can optionally include using acceleration data from each of the one or more removable haptic pads and the one or more reference point pads to virtually map the location of each of the one or more removable haptic pads relative to the one or more reference point pads.

In Example M5, the subject matter of any one of the Examples M1-M4 can optionally include where the one or more removable haptic pads are added when the user is in the virtual environment.

In Example AAAA1, is an electronic device including a communication engine to communicate with at least one reference point pad located on a user and a haptic actuator location engine to determine a position of one or more removable haptic pads on the user based on sensor data received from the one or more removable haptic pads and the at least one reference point pad.

In Example AAAA2, the subject matter of Example AAAA1 can optionally include where the sensor data is motion data from an accelerometer located in the one or more removable haptic pads and the at least one reference point pad.

In Example AAAA3, the subject matter of any one of Examples AAAA1-AAAA2 can optionally include where the haptic actuator location engine uses acceleration data from each of the one or more removable haptic pads and the at least one reference point pad to map the position of each of the one or more removable haptic pads relative to the at least one reference point pad.

In Example AAAA4, the subject matter of any one of Examples AAAA1-AAAA3 can optionally include where in response to determining that at least one of the one or more removable haptic pads is moved to a new position, the haptic actuator location engine determines the new position for each of the at least one of the one or more removable haptic pads that were moved without the user having to recalibrate.

What is claimed is:

1. An electronic device comprising:
a virtual reality engine to create a virtual environment;
a communication engine to communicate with at least one reference point pad located on a user; and
a haptic actuator location engine to determine a position of one or more removable haptic pads on the user based on sensor data received from the one or more removable haptic pads and the at least one reference point pad.

2. The electronic device of claim 1, wherein the sensor data is motion data from one or more sensors located in the one or more removable haptic pads and the at least one reference point pad.

3. The electronic device of claim 2, wherein the one or more sensors is an accelerometer.

4. The electronic device of claim 2, wherein the motion data is associated with a calibration movement the user performs in the virtual environment.

5. The electronic device of claim 1, wherein the haptic actuator location engine maps the position of each of the one or more removable haptic pads relative to the at least one reference point pad.

6. The electronic device of claim 1, wherein the haptic actuator location engine uses acceleration data from each of the one or more removable haptic pads and the at least one reference point pad to map the position of each of the one or more removable haptic pads relative to the at least one reference point pad.

7. The electronic device of claim 6, wherein using the map, a vector distance from each of the one or more removable haptic pads relative to the at least one reference point pad is used to determine the position of each of the one or more removable haptic pads on the user.

8. The electronic device of claim 6, wherein principal component analysis (PCA) is used to map the acceleration data from each of the one or more removable haptic pads relative to the at least one reference point pad.

9. The electronic device of claim 1, wherein the removable haptic pads are attached to the user using straps and the removable haptic pads provide haptic feedback to the user when the user is engaged with the virtual environment.

10. The electronic device of claim 1, wherein in response to determining that at least one of the one or more removable haptic pads is moved to a new position, the haptic actuator location engine determines the new position for each of the at least one of the one or more removable haptic pads that were moved without the user having to recalibrate.

11. A method comprising:
identifying an addition of one or more removable haptic pads to a user;
collecting sensor data from each of the added one or more removable haptic pads and from one or more reference point pads; and
determining a location on the user where each of the one or more removable haptic pads were added.

12. The method of claim 11, wherein the sensor data is motion data from an accelerometer located in each of the one or more removable haptic pads and the one or more reference point pads.

13. The method of claim 12, wherein the motion data is from a calibration movement when the user is in a virtual environment.

14. The method of claim 11, further comprising:
using acceleration data from each of the one or more removable haptic pads and the one or more reference point pads to virtually map the location of each of the one or more removable haptic pads relative to the one or more reference point pads.

15. The method of claim 11, wherein the one or more removable haptic pads are added when the user is in a virtual environment.

16. A virtual reality system comprising:
a virtual reality engine to create a virtual environment for a user, wherein the virtual environment includes haptic feedback to the user;
a haptic system worn by the user, wherein the haptic system includes one or more reference point pads and one or more removable haptic pads;
a communication engine in communication with at least one reference point pad on the user and the one or more removable haptic pads; and
a haptic actuator location engine to determine a location of each of the one or more removable haptic pads on the user using sensor data from each of the one or more removable haptic pads and the one or more reference point pads.

17. The virtual reality system of claim 16, wherein the sensor data is motion data from an accelerometer located in each of the one or more removable haptic pads and the one or more reference point pads.

18. The virtual reality system of claim 17, wherein each of the reference point pads and the one or more removable haptic pads are individually attached to a user and not attached to a haptic suit or haptic vest.

19. The virtual reality system of claim 16, wherein the haptic actuator location engine uses acceleration data from each of the one or more removable haptic pads and the one or more reference point pads to virtually map the location of each of the one or more removable haptic pads relative to the one or more reference point pads.

20. The virtual reality system of claim 19, wherein using the virtual map, a vector distance from each of the one or more removable haptic pads relative to the one or more reference point pads is used to determine the location of each of the one or more removable haptic pads on the user.

21. The virtual reality system of claim 16, wherein the one or more reference point pads includes four reference point pads with a first reference point pad located on a right wrist area of the user, a second reference point pad located on a left wrist area of the user, a third reference point pad located on a right ankle area of the user, and a fourth reference point pad located on a left ankle area of the user.

22. An electronic device comprising:
a communication engine to communicate with at least one reference point pad located on a user; and
a haptic actuator location engine to determine a position of one or more removable haptic pads on the user based on sensor data received from the one or more removable haptic pads and the at least one reference point pad.

23. The electronic device of claim 22, wherein the sensor data is motion data from an accelerometer located in the one or more removable haptic pads and the at least one reference point pad.

24. The electronic device of claim 22, wherein the haptic actuator location engine uses acceleration data from each of the one or more removable haptic pads and the at least one reference point pad to map the position of each of the one or more removable haptic pads relative to the at least one reference point pad.

25. The electronic device of claim 22, wherein in response to determining that at least one of the one or more removable haptic pads is moved to a new position, the haptic actuator location engine determines the new position for each of the at least one of the one or more removable haptic pads that were moved without the user having to recalibrate.
